(19) United States
(12) Patent Application Publication
(10) Pub. No.: US 2018/0285817 A1
(43) Pub. Date: Oct. 4, 2018

(54) NOTIFICATION APPARATUS AND METHOD FOR CONTROLLING SAME

(71) Applicant: CANON KABUSHIKI KAISHA, Tokyo (JP)

(72) Inventor: Ryuya Oka, Kawasaki-shi (JP)

(21) Appl. No.: 15/933,564

(22) Filed: Mar. 23, 2018

(30) Foreign Application Priority Data
Mar. 28, 2017 (JP) 2017-063034

(51) Int. Cl. G06Q 10/10; G06F 17/24; G06F 3/0484

(52) U.S. Cl. CPC G06Q 10/10; G06F 3/0484; G06F 17/246

(57) ABSTRACT

A notification apparatus according to the present invention includes: a display unit configured to display part of data containing at least one object, on a screen; a specification unit configured to specify an object not displayed on the screen, based on position information on the respective objects in the data; and a notification unit configured to notify information on the specified object.

### BACKGROUND OF THE INVENTION

### Field of the Invention

The present invention relates to the notification of an unidentified object in electronic data.

### Description of the Related Art

There have been known technologies by which identified objects and unidentified objects are organized and displayed to be easily viewable when the plurality of objects is displayed on a screen.

For example, there has been disclosed a technology by which objects other than those having been displayed and determined not to be displayed again among the plurality of objects are displayed on a screen (Japanese Patent Application Laid-open No. 2014-157580).

### SUMMARY OF THE INVENTION

For example, a user organizes objects in data and displays the same on a screen with a technology like the one described above to identify the contents of the data. Then, after confirming whether there is no problem in the contents of the data, the user uses the data to perform an operation such as copying, transferring, compressing, e-mailing, and encrypting.

However, even with the above technology for organizing objects in data, the user faces the problem of overlooking some of the objects not easily found in the data.

The present invention has been made in view of the above problem and provides a technique capable of preventing a user from overlooking information in data during the identification of the data.

The present invention in its first aspect provides a notification apparatus comprising:

a display unit configured to display part of data containing at least one object, on a screen;

a specification unit configured to specify an object not displayed on the screen, based on position information on the respective objects in the data; and

a notification unit configured to notify information on the specified object.

The present invention in its second aspect provides a method for controlling a notification apparatus connected to a display apparatus on which an image is displayed, the method comprising:

displaying part of data containing at least one object, on a screen;

specifying an object not displayed on the screen, based on position information on the respective objects in the data; and

notifying information on the specified object.

The present invention in its third aspect provides a non-transitory computer readable medium that stores a program, wherein

the program causes a computer to execute a method for controlling a notification apparatus connected to a display apparatus on which an image is displayed, and

the method includes:

displaying part of data containing at least one object, on a screen;

specifying an object not displayed on the screen, based on position information on the respective objects in the data; and

notifying information on the specified object.

Thus, it is possible for a user to be prevented from overlooking information in data during the identification of the data.

Further features of the present invention will become apparent from the following description of exemplary embodiments with reference to the attached drawings.

### BRIEF DESCRIPTION OF THE DRAWINGS

FIG. 1 is a block diagram for describing a hardware configuration example of an alert display apparatus;

FIG. 2 is a block diagram showing a software configuration example of the alert display apparatus according to a first embodiment;

FIG. 3 is a diagram for illustrating by an example the flow of the processing of the alert display apparatus according to the first embodiment;

FIGS. 4A to 4G are diagrams each showing an example of processing for specifying an unidentified object;

FIGS. 5A to 5H are diagrams each showing an example of a pop-up for notifying a user of an alert;

FIG. 6 is a block diagram showing a software configuration example of an alert display apparatus according to a second embodiment; and

FIG. 7 is a diagram for illustrating by an example the flow of the processing of the alert display apparatus according to the second embodiment.

### DESCRIPTION OF THE EMBODIMENTS

Hereinafter, preferred embodiments of the present invention will be described in detail with reference to the drawings. In respective figures, the same configurations will be given the same reference symbols in principle, and their duplicated descriptions will be omitted. In addition, numerical values illustrated by an example to embody descriptions or the like are not limited unless otherwise particularly described.

Moreover, the present invention is not limited to the following embodiments but changeable without departing from its spirit. For example, the respective configurations of the following embodiments may be appropriately modified or changed depending on apparatus configurations and various conditions to which the present invention is applied.

### First Embodiment

Hardware Configurations of Alert Display Apparatus 200

Hereinafter, a preferred embodiment of the present invention will be described with reference to the drawings. In the embodiment, the present invention is applied to equipment such as a personal computer (PC) and a smart phone having the functions of performing operations such as copying, transferring, compressing, e-mailing, and encrypting of electronic data and the functions of displaying and editing electronic data.

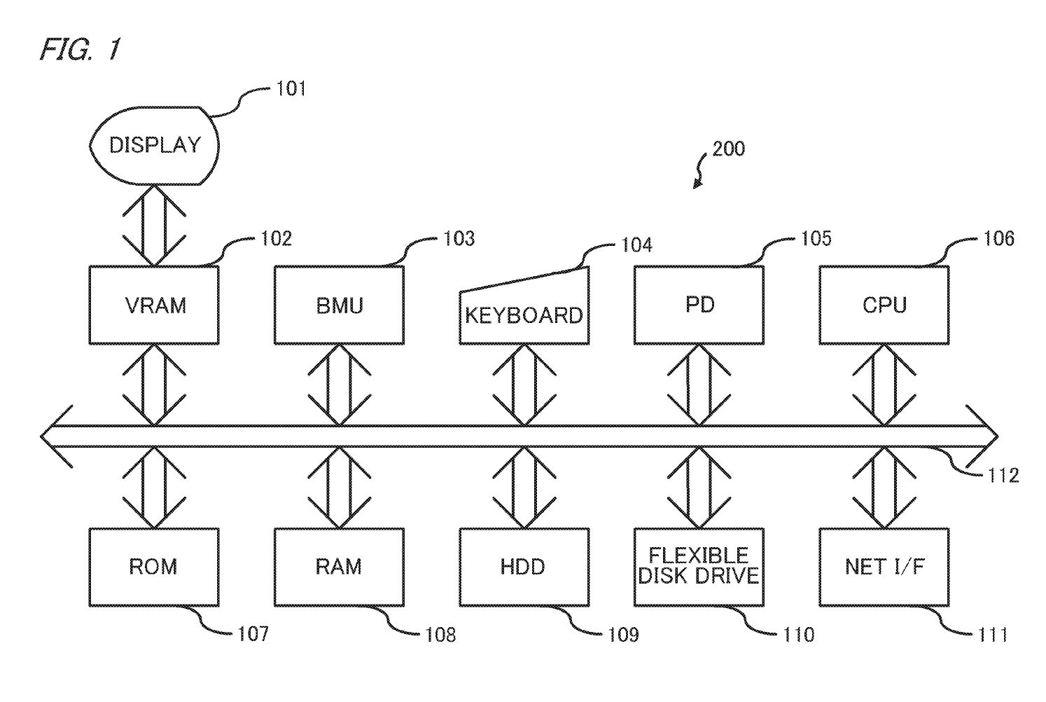

FIG. 1 is a block diagram for describing a hardware configuration example of an alert display apparatus 200. The embodiment will describe the alert display apparatus 200 as an example of a notification apparatus. Note that a second embodiment has the same hardware configurations.

As shown in FIG. 1, the alert display apparatus 200 has a display 101, a video random access memory (VRAM) 102, a bit move unit (BMU) 103, a keyboard 104, a pointing device (PD) 105, and central processing unit (CPU) 106. In addition, the alert display apparatus 200 has a read only memory (ROM) 107, a random access memory (RAM) 108, a hard disk drive (HDD) 109, and a flexible disk drive 110. Moreover, the alert display apparatus 200 has a network (NET) I/F 111 and a bus 112.

The display 101 displays, for example, icons, messages, menus, and other user interface information to manage the alert display apparatus.

The VRAM 102 stores data to be displayed on the display 101. Data stored in the VRAM 102 is transferred to the display 101 according to a prescribed procedure to display an image on the display 101.

The BMU 103 controls, for example, the data transfer between memories (for example, between the VRAM 102 and other memories) and the data transfer between the memories and respective input/output (I/O) devices (for example, the network I/F 111).

The keyboard 104 has various keys to input information such as characters. When the keyboard 104 is not provided as hardware, a software keyboard may be used instead.

The pointing device (PD) 105 is used to select, for example, icons, menus, or the like displayed on the display 101. For example, a mouse, a touch panel, a pen tablet, a touch pad, a track pad, a track ball, or the like is used as the PD 105.

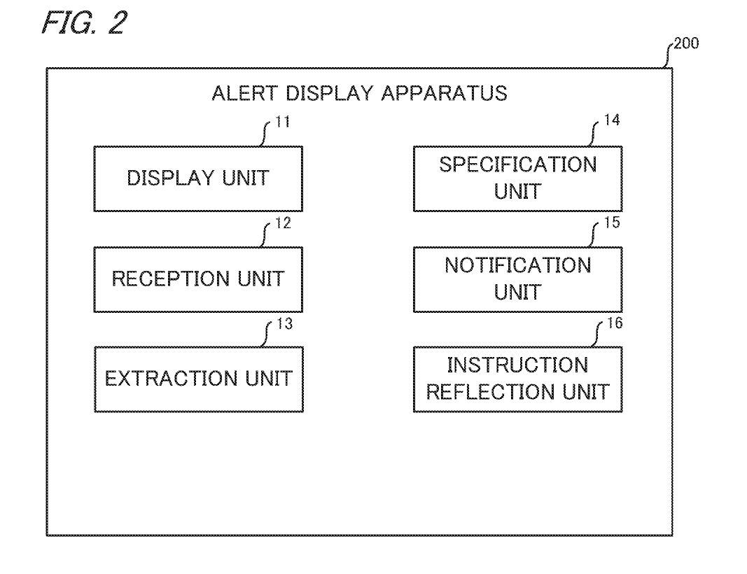

The CPU 106 controls respective devices based on an operating system (OS) and control programs such as a program for performing processing that will be described below, the OS and the control programs being stored in the ROM 107, the HDD 109, or the flexible disk drive 110. In addition, the CPU 106 develops programs recorded on the ROM 107 or the like into the RAM 108 and performs the processing of respective processing units shown in FIG. 2 that will be described later.

The ROM 107 stores various control programs and data. The RAM 108 has a work area for the CPU 106, a save area for data in error processing, a load area for control programs, or the like. The HDD 109 stores data such as respective control programs performed in the alert display apparatus 200 and temporarily-stored data.

The network I/F 111 is a communication interface that communicates with external storage media, cameras, printers, or the like via a network.

The bus 112 is a communication path for data sent and received between the respective hardware of the alert display apparatus 200. The bus 112 is, for example, an address bus, a data bus, or a control bus.

Control programs may be offered to the CPU 106 from the ROM 107, the HDD 109, and the flexible disk drive 110, or may be offered from other alert display apparatuses via a network through the network I/F 111.

Software Configurations of Alert Display Apparatus 200

FIG. 2 is a block diagram showing a software configuration example of the alert display apparatus 200 according to the first embodiment.

The alert display apparatus 200 has a display unit 11, a reception unit 12, an extraction unit 13, a specification unit 14, a notification unit 15, and an instruction reflection unit 16. Hereinafter, the respective processing units of the alert display apparatus 200 will be described.

The display unit 11 causes an image based on data containing at least one object to be displayed on the screen of the display 101. Objects are elements such as character strings and graphics contained in electronic data.

The reception unit 12 receives instructions to operate electronic data. For example, the reception unit 12 receives operating instructions such as transferring, copying, sending, compressing, and encrypting of electronic data.

The extraction unit 13 extracts modules for detecting respective objects contained in electronic data from the ROM 107. Here, modules represent units for acquiring the positions and the contents of respective objects. In addition, modules are provided in advance corresponding to electronic data and include, for example, a module for a spreadsheet application, a module for a text editing application, a module for a presentation-material creating application, or the like.

The specification unit 14 specifies an object with a high likelihood of being not identified by a user based on position information on respective objects when electronic data is displayed on a screen. Note that an object predicted by the alert display apparatus 200 as being not identified by a user will be called an unidentified object below.

For example, the specification unit 14 may specify an unidentified object according to at least any of the following methods (1) to (4). (1) There is a case that part of electronic data does not fall within the display region of a screen when the electronic data is displayed on the screen. In this case, the specification unit 14 specifies an object outside the display region of the screen displayed on the display 101 as an unidentified object. Note that the display region represents a region displayed on the screen. (2) The specification unit 14 identifies the positions of respective objects in electronic data, and determines an object at a position away from a display region by at least a certain distance as an unidentified object. (3) The specification unit 14 regards a plurality of objects arranged at an interval within a prescribed distance as a group, and specifies respective objects, all of which belong to a group outside the display region of a screen when electronic data is displayed on the screen, as unidentified objects. (4) The specification unit 14 specifies an object, which has substantially the same color as the background color of a screen when electronic data is displayed on the screen, as an unidentified object. Note that a specific method for specifying an unidentified object will be described later.

The notification unit 15 notifies a user of information on a specified unidentified object. Note that a specific notified content will be described later.

The instruction reflection unit 16 deletes an unidentified object from electronic data according to instructions from a user in response to notification by the notification unit 15.

Flow of Processing

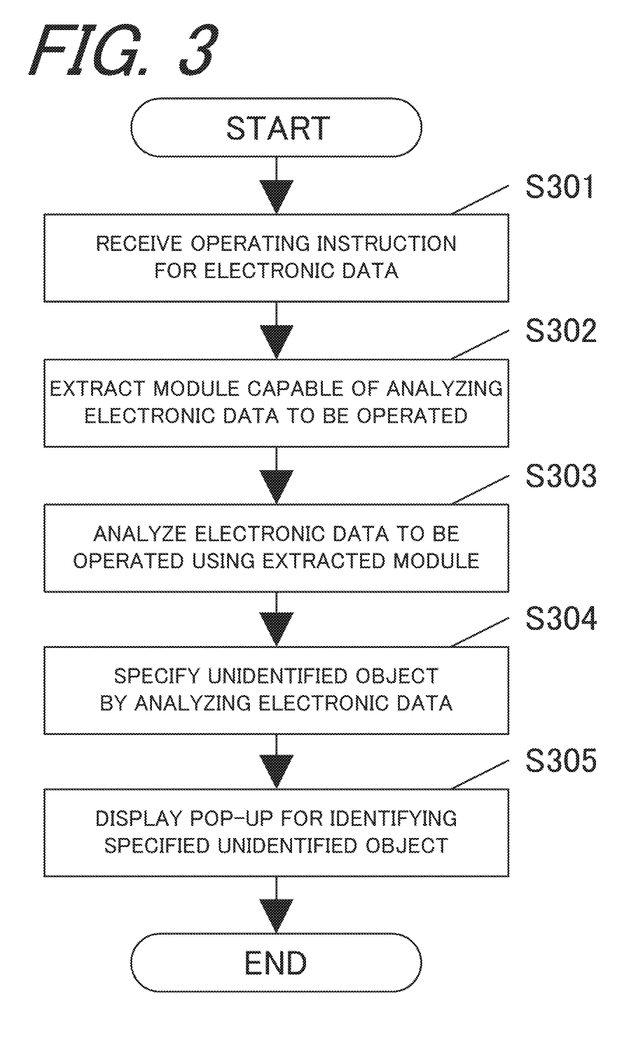

FIG. 3 is a diagram for illustrating by an example the flow of the processing of the alert display apparatus 200 according to the first embodiment. In the flow of FIG. 3, the flow of processing in a case in which a user identifies the file of a spreadsheet application will be described.

In step S301, the reception unit 12 receives operating instructions such as transferring, copying, sending, compressing, and encrypting of electronic data from the user.

In step S302, the extraction unit 13 extracts a module capable of analyzing the electronic data to be operated from the ROM 107. Since a spreadsheet application is used in the embodiment, the extraction unit 13 extracts a module for a spreadsheet application from the ROM 107.

In step S303, the specification unit 14 analyzes the electronic data to be operated using the module for the spreadsheet application extracted in step S302. Specifically, using the module for the spreadsheet application, the specification unit 14 acquires information such as the positions (row numbers and column numbers) and the contents of the respective cells of the spreadsheet application to which character strings have been input.

In step S304, the specification unit 14 specifies a cell including an unidentified object from the cells of which the information has been acquired in step S303.

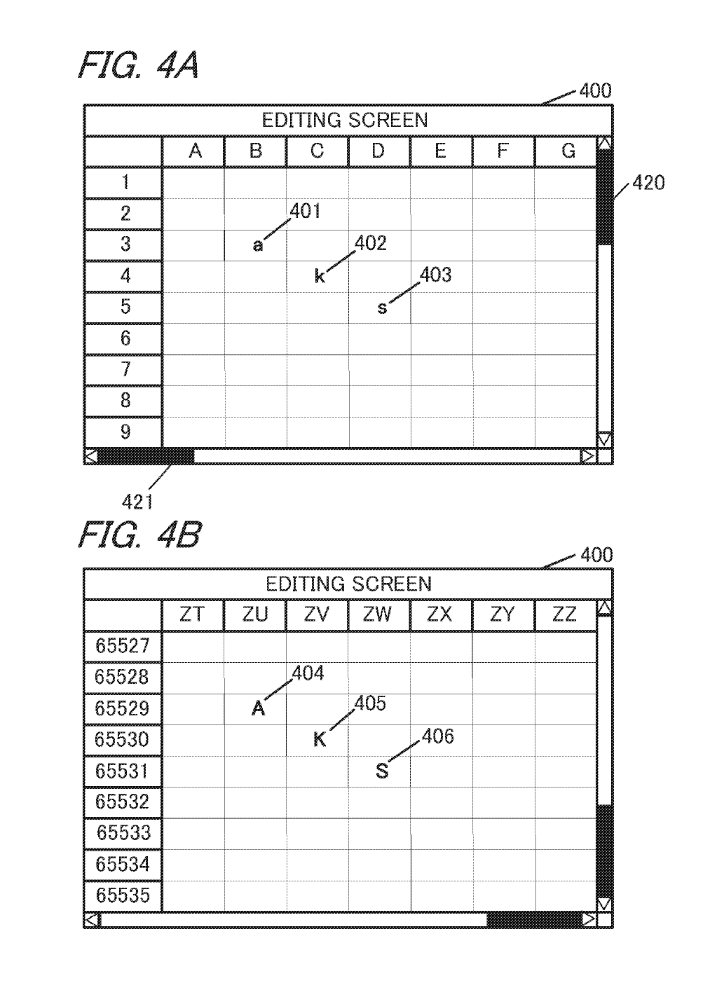

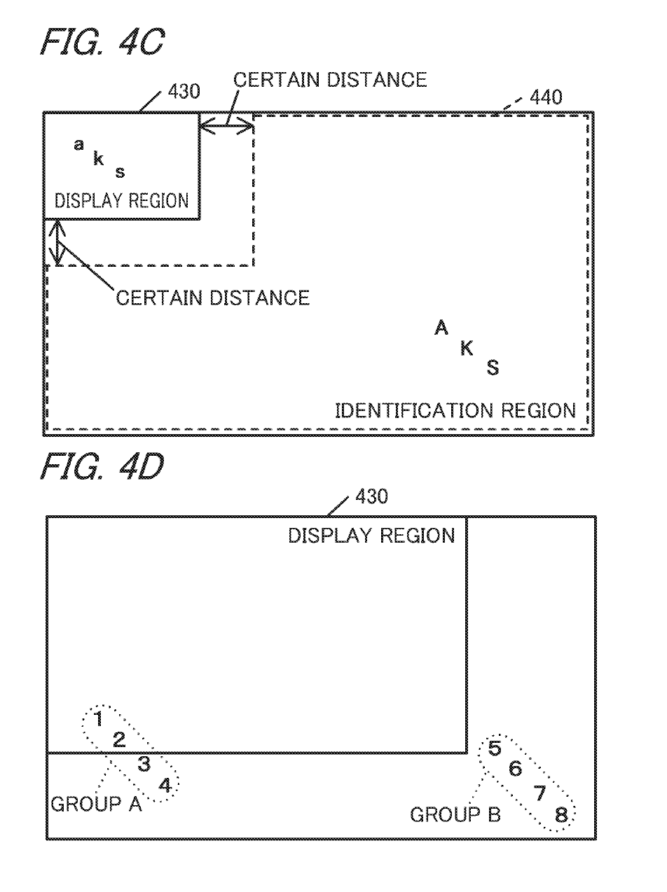

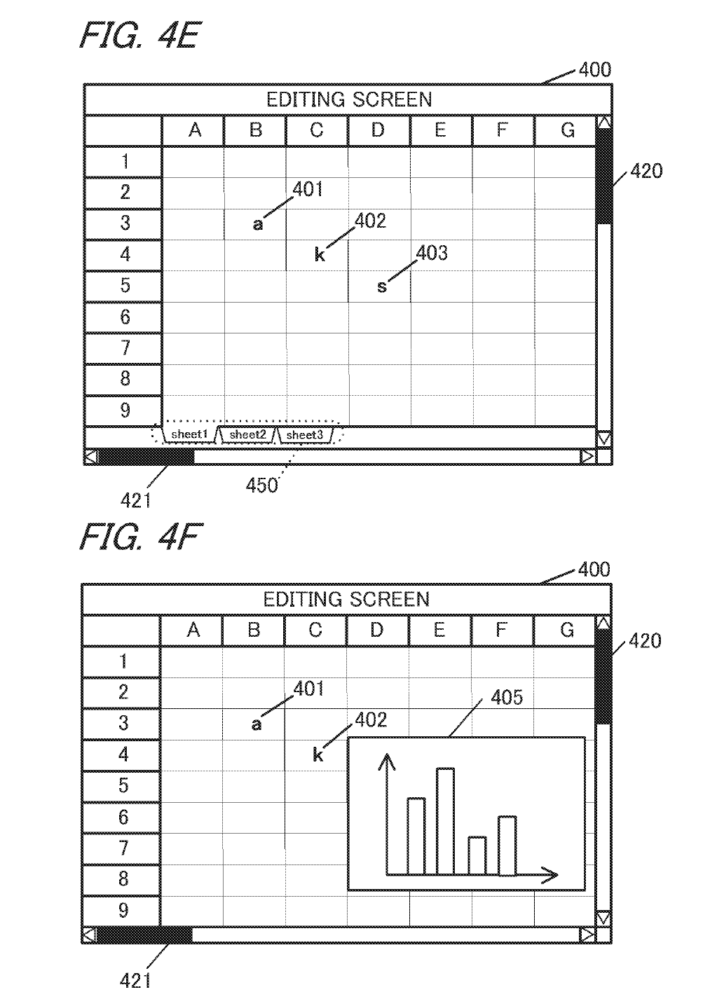

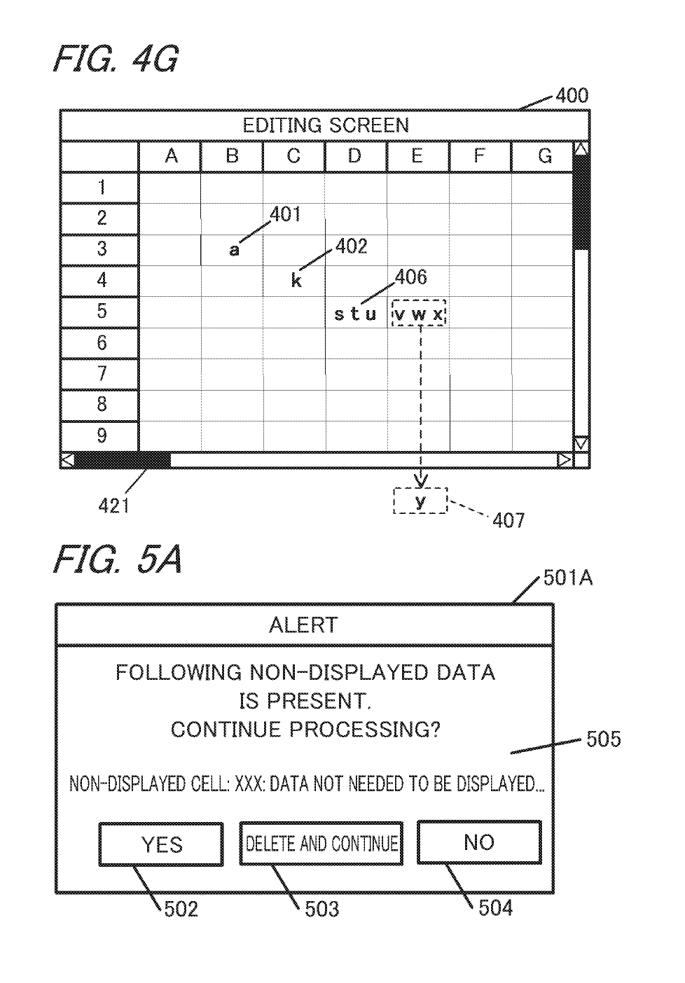

FIGS. 4A to 4G are diagrams showing an example of processing for specifying an unidentified object. Hereinafter, the specification of an unidentified object will be described using a specific example.

FIG. 4A shows a screen initially displayed when the file (electronic data) of a spreadsheet application is opened. An editing screen 400 of FIG. 4A displays the range of row numbers 1 to 9 and column numbers A to G in which an object 401 representing “a,” an object 402 representing “k,” and an object 403 representing “s” are displayed. In addition, the editing screen 400 displays a vertical scroll bar 420 for scrolling a display region in a vertical direction and a horizontal scroll bar 421 for scrolling the display region in a horizontal direction. A user is allowed to refer to an object arranged outside the display region by operating the vertical scroll bar 420 and the horizontal scroll bar 421.

In addition, the editing screen 400 of FIG. 4B displays the range of row numbers 65527 to 65535 and column numbers ZT to ZZ in which an object 404 representing “A,” an object 405 representing “K,” and an object 406 representing “S” are displayed. Since the objects 401 to 403 of FIG. 4A are positioned away from the objects 404 to 406 of FIG. 4B, all the objects are not allowed to be displayed together in one screen.

FIG. 4C is a diagram showing the positional relationship between the objects 401 to 403 and the objects 404 to 406. A display region 430 is a region initially displayed on the screen when the file is opened and includes the objects 401 to 403. In addition, an identification region 440 is a region positioned away from the display region 430 by at least a certain distance and includes the objects 404 to 406.

The objects 401 to 403 inside the display region 430 are displayed when the user opens the file. On the other hand, the objects 404 to 406 in the identification region 440 are not allowed to be displayed inside the screen unless the user scrolls the display region 430 by at least a certain distance in the vertical and horizontal directions with the vertical scroll bar 420 and the horizontal scroll bar 421. Therefore, it is highly likely that the user does not find out about the presence of the objects 404 to 406 in the identification region 440 when opening and identifying the file, and thus the user could overlook the information in the file.

In view of this, the specification unit 14 specifies the objects 404 to 406 included in the identification region 440 positioned away from the display region 430 by at least the certain distance as unidentified objects.

The above embodiment includes but not limited to an example in which objects positioned away from a display region by at least a certain distance are determined as unidentified objects. For example, the specification unit 14 may regard a plurality of objects arranged at an interval within a prescribed distance as a group and determine respective objects included in the group as unidentified objects except that part of the group is present in a display region. A specific example will be described using FIG. 4D.

FIG. 4D shows an example of a case in which the groups of objects are displayed on the screen. The specification unit 14 regards objects “1,” “2,” “3,” and “4” arranged at an interval within a prescribed distance as a group A. Similarly, the specification unit 14 regards objects “5,” “6,” “7,” and “8” arranged at an interval within a prescribed distance as a group B.

Here, as for the group A, the objects “3” and “4” are positioned outside the display region 430, but the objects “1” and “2” are displayed inside the display region 430. Therefore, it is highly likely that the user scrolls the screen in the vertical direction to identify the objects “3” and “4.” Accordingly, it is not likely that the user does not find out about the presence of the objects “3” and “4” outside the display region 430.

On the other hand, as for the group B, all the objects “5,” “6,” “7,” and “8” are positioned outside the display region 430. Therefore, the user may not scroll the screen, and thus it is highly likely that the user does not find out about the presence of the objects “5,” “6,” “7,” and “8.”

In view of this, the specification unit 14 specifies the respective objects “5,” “6,” “7,” and “8” belonging to the group B in which all the objects are positioned outside the display region 430 as unidentified objects.

FIG. 4E is a diagram showing an example of a case in which a plurality of editable sheets is present. In the example of FIG. 4E, three editable “sheet 1,” “sheet 2,” and “sheet 3” are present and made changeable when tabs 450 are selected. The “sheet 1” is displayed when the user opens the file, and objects in the “sheet 2” and the “sheet 3” are not identifiable unless user operates the tabs 450. Therefore, the user easily overlooks the objects in the “sheet 2” and the “sheet 3.”

In view of this, the specification unit 14 specifies the objects in the “sheet 2” and the “sheet 3” other than the currently-displayed “sheet 1” as unidentified objects.

FIG. 4F is a diagram showing an example of a case in which a character-string object is hidden under a graphic object. In FIG. 4F, it is assumed that the object 401 representing “a,” the object 402 representing “k,” and the object 403 representing “s” are arranged at the same positions as those shown in FIG. 4A. In addition, it is assumed that a bar-graph object 405 is arranged, the object 403 representing “s” is hidden under the bar-graph object 405, and the object 403 representing “s” is made unseeable.

In this case, since the user is not allowed to identify the object 403 representing “s” unless he/she moves the bar-graph object 405, it is highly likely that the user overlooks the object 403 representing “s.”

In view of this, the specification unit 14 specifies an object hidden under a graphic object such as the object 403 representing “s” as an unidentified object.

FIG. 4G is a graph showing an example of a case in which a character-string object is hidden under other character-string objects. In FIG. 4G, character-string objects 406 representing “stuvwx” are present at a position “D5,” and a character-string object 407 representing “y” at an adjacent position “E5” is hidden. Since the user is not allowed to identify the character-string object 407 representing “y” unless he/she performs an operation such as the activation of the cell of “E5,” it is highly likely that the user overlooks the character-string object 407 representing “y.”

In view of this, the specification unit 14 specifies an object hidden under adjacent character-string objects such as the object 407 representing “y” as an unidentified object.

In addition, the specification unit 14 may specify an object having substantially the same color (similar color) as the background color of a display screen as an unidentified object. For example, the specification unit 14 calculates a difference in the RGB value between a background color and respective objects, and specifies an object of which the difference is not more than a threshold as an unidentified object.

For example, when the background color of a display screen is white and the color of a character-string object is beige, a difference in the RGB value between the background color and the character-string object is not more than a threshold. Therefore, the specification unit 14 specifies the character-string object as an unidentified object.

In addition, the specification unit 14 may specify an object having a small font size among a plurality of character-string objects included in the file as an unidentified object. For example, when at least 90% of character-string objects have a font size of 16 Pt while some of the character-string objects have a font size of 8 Pt, the specification unit 14 specifies the character-string objects having a font size of 8 Pt as unidentified objects.

The processing of FIG. 3 will be described again. In step S305, the notification unit 15 displays a pop-up for identifying the unidentified object specified in step S304. Hereinafter, a specific example of the pop-up displayed in step S305 will be described.

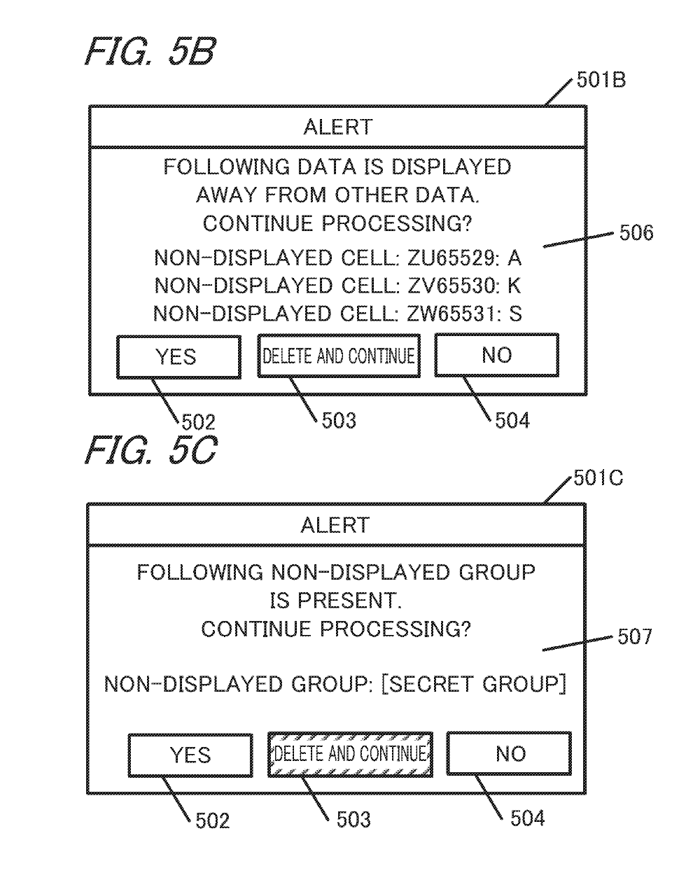

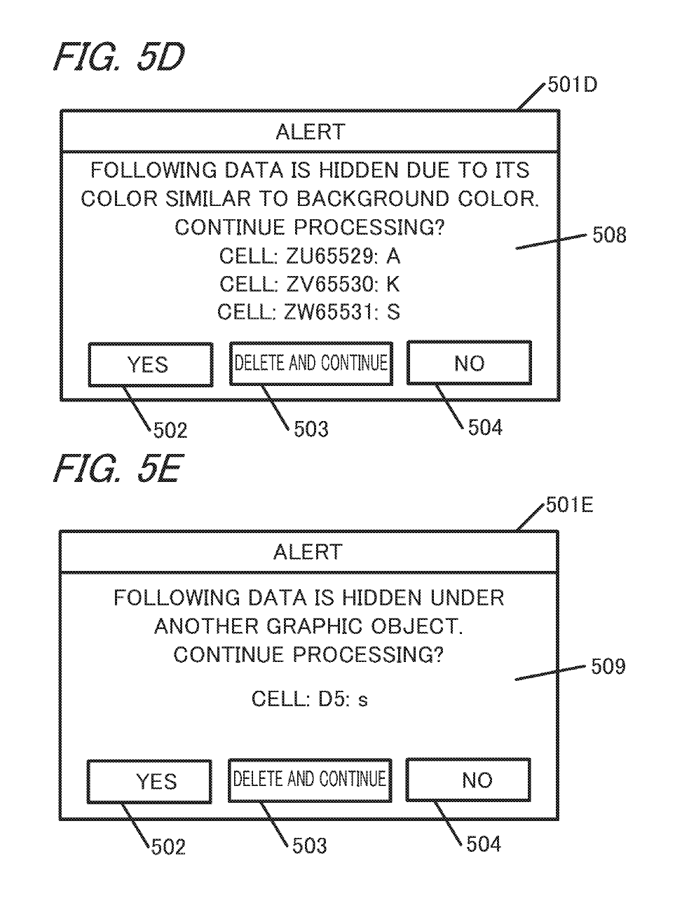

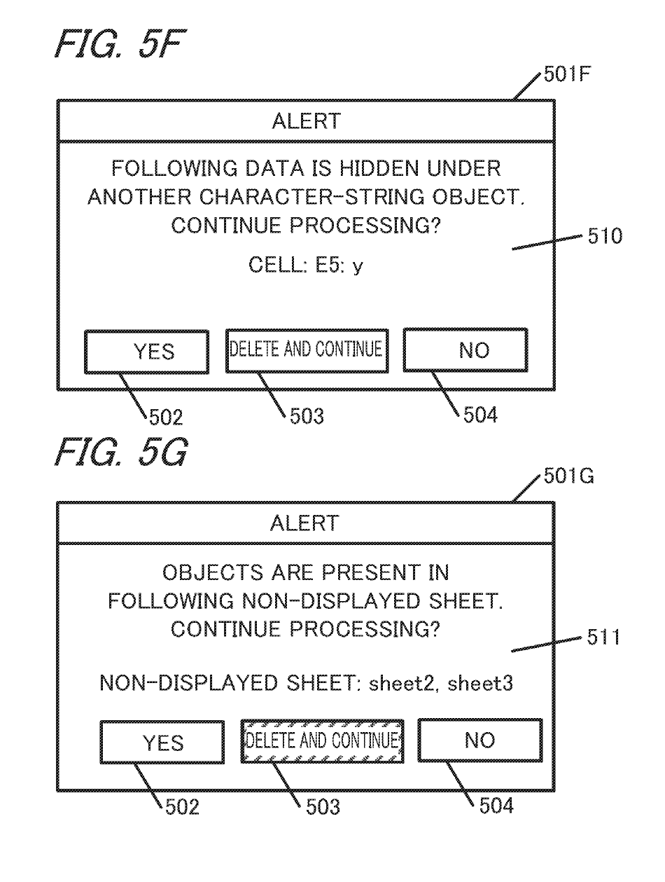

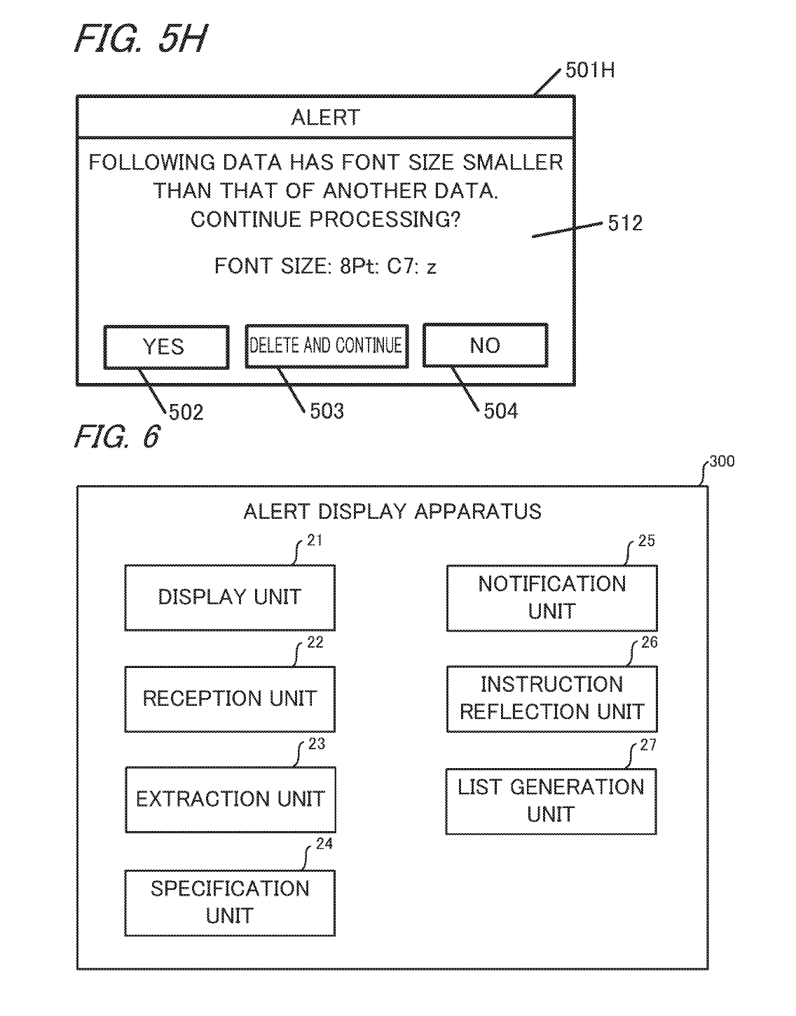

FIGS. 5A to 5H are diagrams each showing an example of a pop-up for notifying a user of an alert.

FIG. 5A shows an example of a pop-up displayed when the presence of an unidentified object is specified. For example, a pop-up 501A is displayed when the user performs an operation such as copying, transferring, compressing, e-mailing, and encrypting. Note that pop-ups 501B to 501H that will be described later are also displayed at the same timing.

A message 505 includes the position and the content of an object specified as an unidentified object and a message for confirming whether a prescribed operation such as copying, transferring, e-mailing, and encrypting may be continuously performed.

When a button 502 is pressed, the instruction reflection unit 16 continuously performs the prescribed operation without performing particular processing on the unidentified object. When a button 504 is pressed, the instruction reflection unit 16 stops the prescribed operation and displays an original screen. When a button 503 is pressed, the instruction reflection unit 16 generates electronic data obtained by deleting the unidentified object from original electronic data and performs the prescribed operation on the obtained electronic data. Thus, the user saves the labor of editing electronic data again and improves convenience.

FIG. 5B shows an example of a pop-up for notifying the user of the presence of unidentified objects outside a display region. A pop-up 501B is, for example, a pop-up displayed in the cases of FIGS. 4A, 4B, and 4C. A message 506 of the pop-up 501B displays the position “ZU65529” and the content “A” of the object 404 and the position “ZV65530” and the content “K” of the object 405, the objects 404 and 405 being not displayed in the display region. In addition, the message 506 displays the position “ZW65531” and the content “S” of the object 406.

Thus, the user is allowed to identify objects positioned away from a display region by at least a certain distance and prevent the overlook of the objects.

In addition, in the case of FIG. 4D, the notification unit 15 displays information such as the respective positions of the respective objects “5,” “6,” “7,” and “8” included in the group B outside the display region in the pop-up 501B. Thus, since the user is notified of a group of which all objects are positioned outside a display region, he/she is allowed to prevent the overlook of the objects.

FIG. 5C shows an example of a pop-up displayed when at least a prescribed number of unidentified objects are present. The notification unit 15 displays in a pop-up 501C information on a range in which a plurality of unidentified objects is present when at least a prescribed number of unidentified objects are present. For example, when a multiplicity of unidentified objects is present and all the unidentified objects are not allowed to be displayed in the pop-up 501C, the name of a group including the unidentified objects is displayed in a message 507. Here, a group represents the group of a plurality of objects defined in advance by the user. In addition, the alert display apparatus 200 may automatically determine a group.

In the example of FIG. 5C, since the group of objects called a “secret group” is present outside the display region, the “secret group” is displayed in a message 507 of the pop-up 501C. Thus, even if a multiplicity of unidentified objects is present, the user is allowed to be clearly notified of the presence. Note that in this case, the notification unit 15 may prohibit the pressing of a button 503 to prevent the objects from being falsely deleted.

In addition, the notification unit 15 may display, when at least a prescribed number unidentified objects are present, information such as sheets in which the unidentified objects are arranged and the number of pages in the pop-up 501C. In addition, the notification unit 15 may display information such as the position of a representative unidentified object among at least a prescribed number of unidentified objects in the pop-up 501C.

FIG. 5D shows an example of a pop-up displayed when the color of objects and a background color are similar to each other. For example, a pop-up is displayed when a background color is white and the color of object characters is beige. That is, the pop-up is displayed when the color of the objects is similar to the background color and inconspicuous.

In this case, the notification unit 15 displays the positions and the contents of unidentified objects in a message 508. Thus, the user is allowed to prevent the overlook of inconspicuous objects having a color similar to that of a background.

FIG. 5E shows an example of a pop-up displayed when a non-displayed object is present since the object overlaps with another graphic object. A pop-up 501E is a pop-up displayed, for example, when a state shown in FIG. 4F is created.

In the state shown in FIG. 4F, the character-string object 403 representing “s” is not displayed since the object 403 is hidden under the bar-graph object 406. In this case, as shown in FIG. 5E, the notification unit 15 may display the position “D5” and the content “s” of the object 403 as an unidentified object in a message 509.

Thus, the user is allowed to prevent the overlook of a non-displayed object overlapping with another graphic object.

FIG. 5F shows an example of a pop-up displayed when a non-displayed object is present since the object overlaps with other character-string objects. As in FIG. 4G, when the object 407 representing “y” is hidden and is not displayed since the character string of the objects 406 is long, the notification unit 15 may display the position “E5” and the content “y” of the object 407 as an unidentified object in a message 510.

Thus, the user may prevent the overlook of a non-displayed object overlapping with other character-string objects.

FIG. 5G shows an example of a pop-up displayed when objects are present in sheets different from a currently-displayed sheet. As in the case of FIG. 4E, a pop-up 501G is a pop-up displayed when a plurality of editable sheets is present and may be switched and displayed by a tab operation.

In this case, when unidentified objects are present in the non-displayed “sheet 2” and the “sheet 3” other than the currently-displayed “sheet 1,” the notification unit 15 displays the non-displayed “sheet 2” and “sheet 3” in a message 511. Note that the notification unit 15 may further display the positions or the like of the unidentified objects arranged in the non-displayed sheets in a list form in the message 511.

Thus, the user is allowed to prevent the overlook of objects included in sheets other than a currently-displayed sheet. Note that in this case, the notification unit 15 may prohibit the pressing of the button 503 to prevent the objects from being falsely deleted.

FIG. 5H shows an example of a pop-up displayed when a character-string object having a font size smaller than that of other character-string objects is included. For example, a pop-up is displayed when a character-string object displayed at a font size of 8 Pt is present while other character-string objects is displayed at a font size of 18 Pt. In this case, the notification unit 15 may display the font size “8 Pt,” the position “C7,” and the content “z” of the character-string object having the font size 8 Pt in a message 311. Thus, the user is allowed to prevent the overlook of a character-string object having a small font size.

According to the embodiment, the alert display apparatus 200 specifies an object with a high likelihood of being not identified by a user and notifies the user of the presence of the object to prevent the overlook of the object as described above. Thus, the alert display apparatus 200 may prevent the user from forgetting about deleting confidential information having high confidentiality or the like and improve safeness and convenience.

Note that the above embodiment includes but not limited to a case in which a pop-up is displayed after a user performs an operation such as copying, transferring, e-mailing, and encrypting. For example, the notification unit 15 may display a pop-up at the end or the like of the screen during a user's operation. In addition, the notification unit 15 may display a pop-up having high transparency in the screen during a user's operation.

Note that since the number of unidentified objects increases or decreases according to a user's operation when a pop-up is displayed during the operation like this, the notification unit 15 may appropriately update a message in the pop-up according to an operating status.

### Second Embodiment

FIG. 6 is a block diagram showing a software configuration example of an alert display apparatus 300 according to a second embodiment. The CPU 106 develops a program stored in the ROM 107 or the like into the RAM 108 and performs the processing of the respective processing units of FIG. 6 that will be described later.

The alert display apparatus 300 of FIG. 6 is different from the alert display apparatus 200 of FIG. 2 in that the alert display apparatus 300 has a list generation unit 27. The list generation unit 27 generates a list in which objects having been displayed on the screen are recorded from among objects in electronic data. Then, the list generation unit 27 stores the generated list in the HDD 109.

A specification unit 24 specifies an object not included in a list generated by the list generation unit 27 as an unidentified object. A notification unit 25 displays the position and the content of a specified unidentified object in a pop-up to notify a user of the presence of the object.

Note that the hardware configurations of the alert display apparatus 300 are the same as those of the alert display apparatus 200 of FIG. 2.

Flow of Processing

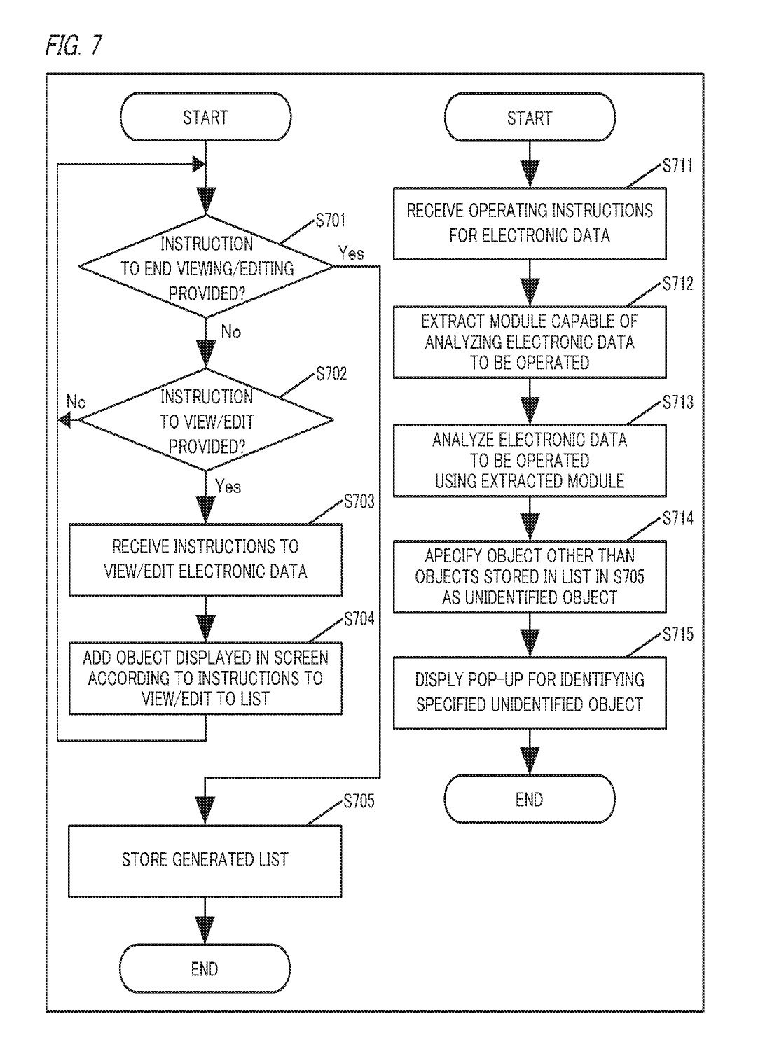

FIG. 7 is a diagram for illustrating by an example the flow of the processing of the alert display apparatus 300 according to the second embodiment. In the embodiment, the processing of steps S711 to S715 is performed after the processing of steps S701 to S705.

In step S701, the alert display apparatus 200 determines whether instructions to end the viewing or editing of electronic data have been provided by a user. When the instructions have not been provided, the processing proceeds to the processing of step S702. The processing of a case in which the instructions have been provided will be described later.

In step S702, the alert display apparatus 200 determines whether instructions to view or edit the electronic data have been provided by the user. When the instructions to view or edit the electronic data have been provided, the processing proceeds to the processing of step S703. On the other hand, when the instructions to view or edit the electronic data have not been provided, the processing returns to the processing of step S701. Note that the instructions to view or edit the electronic data include, for example, the scrolling operation of the screen, the newly input of a character-string object, or the like.

In step S703, the alert display apparatus 200 receives the instructions to view or edit the electronic data by the user. Note that any external apparatus may receive the instructions instead so long as the apparatus has the functions of viewing and editing the electronic data.

In step S704, the list generation unit 27 adds an object displayed on the display 101 according to the instructions received in step S703 to a list as a displayed object. Specifically, the list generation unit 27 appropriately adds an object having been transferred into the display region by the scrolling operation to the list. After that, the alert display apparatus 200 returns to step S701 to perform the processing of step S701 and the subsequent steps again.

When the instructions to end the viewing or editing of the electronic data have been provided in step S701, the list generation unit 27 stores a list of identified objects in the HDD 109. The list stored in step S705 is used in the processing of steps S711 to S715 that will be described later. Note that the list of the identified object may be retained in the electronic data as attached data.

Note that when one or a plurality of lists of identified objects has been stored, the list generation unit 27 may delete the old list of the identified objects and store only the newest list. That is, in step S705, the list generation unit 27 may update the list to the newest state. Thus, in the processing of steps S701 to S705, only objects displayed when the viewing or editing processing of electronic data is performed at the last are handled as identified objects.

Next, the processing of steps S711 to S715 will be described.

In step S711, a reception unit 22 receives operating instructions such as transferring, copying, sending, compressing, and encrypting of electronic data from the user.

In step S712, an extraction unit 23 extracts a module capable of analyzing the electronic data to be operated from the ROM 107.

In step S713, a specification unit 24 analyzes the electronic data to be operated using the module extracted in step S705.

In step S714, the specification unit 24 specifies an object not present in the list of the identified objects among objects included in the electronic data as an unidentified object.

Note that when the list of the identified objects is not present in the HDD 109 in step S714, the specification unit 24 may perform the same processing as that of step S304 of FIG. 3.

In step S715, regarding the object specified in step S714, the notification unit 15 displays a pop-up indicating that the unidentified object is present in the electronic data to notify the user of the presence of the unidentified object.

Thus, since an object displayed on the screen by the scrolling operation or the like is not handled as a notified object and the number of notified unidentified objects reduces, burdens on the user may be reduced.

The present invention is described in detail above based on the preferred embodiments. The present invention is not limited to the specific embodiments but includes various modes without departing from its spirit. The above embodiments may be partially appropriately combined together.

For example, the above embodiments may be applied to cases using applications such as a text editing application and a presentation-material creating application other than a spreadsheet application described in the embodiments.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Further, the present invention also includes a case in which a software program for realizing the functions of the above embodiments is supplied from a recording medium to a system or an apparatus having a computer capable of performing the program directly or through wired/wireless communication to perform the program.

Accordingly, a program code itself supplied to and installed in a computer to realize the function processing of the present invention with the computer also realize the present invention. That is, the present invention also includes a computer program itself for realizing the function processing of the present invention.

In this case, the program may have any mode such as an object code, a program performed by an interpreter, and script data supplied to an OS so long as the program has functions.

In addition, the present invention is applicable to personal computers, personal digital assistants (PDAs), mobile phone terminals, portable image viewers, printing apparatuses with a display, digital photo frames, music players, or the like. Moreover, the present invention is applicable to video game machines, electronic book readers, tablet terminals, smart phones, projection apparatuses, home electric appliances or in-vehicle devices with a display, or the like.

A recording medium for supplying a program may include, for example, a hard disk, a magnetic recording medium such as a magnetic tape, an optical/magnetic optical recording medium, or a non-volatile semiconductor memory.

Further, a method for supplying a program may include a method in which a server on a computer network stores a computer program forming the present invention and a connected client computer downloads and performs the computer program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-063034, filed on Mar. 28, 2017, which is hereby incorporated by reference herein in its entirety.

What is claimed is:

1. A notification apparatus comprising:
a display unit configured to display part of data containing at least one object, on a screen;
a specification unit configured to specify an object not displayed on the screen, based on position information on the respective objects in the data; and
a notification unit configured to notify information on the specified object.

2. The notification apparatus according to claim 1, wherein
the notification unit notifies notification of position information on the specified object in the data.

3. The notification apparatus according to claim 1, wherein
the specification unit specifies an object that is present in a region other than a display region of the screen in a case where the data is displayed on the screen, in the data.

4. The notification apparatus according to claim 1, wherein
the specification unit specifies an object that is present at a position away from a display region of the screen by at least a certain distance in a case where the data is displayed on the screen.

5. The notification apparatus according to claim 1, wherein
the specification unit regards a plurality of objects arranged at an interval within a prescribed distance as a group, and specifies respective objects, all of which belong to a group outside a display region of the screen in case where the data is displayed on the screen.

6. The notification apparatus according to claim 1, wherein
the specification unit further specifies an object having substantially the same color as a background color of the screen in a case where the data is displayed on the screen.

7. The notification apparatus according to claim 1, further comprising:
a list generation unit configured to generate a list in which objects that have been displayed on the screen are recorded from among the objects in the data, wherein
the specification unit specifies an object not included in the list.

8. The notification apparatus according to claim 1, further comprising:
an extraction unit configured to extract a module for detecting the respective objects contained in the data, wherein
the specification unit specifies an object by using the extracted module.

9. The notification apparatus according to claim 1, further comprising:
a reception unit configured to receive an operating instruction for the data, wherein
the notification unit notifies the information on the specified object after the operating instruction for the data is received.

10. The notification apparatus according to claim 1, wherein
the notification unit notifies information on a range in which at least a prescribed number of objects are arranged in a case where the at least prescribed number of the objects are specified by the specification unit.

11. The notification apparatus according to claim 1, further comprising:
a deletion unit configured to delete the object specified by the specification unit from the data according to an instruction received from a user after notifying by the notification unit.

12. A method for controlling a notification apparatus connected to a display apparatus on which an image is displayed, the method comprising:
displaying part of data containing at least one object, on a screen;
specifying an object not displayed on the screen, based on position information on the respective objects in the data; and
notifying information on the specified object.

13. A non-transitory computer readable medium that stores a program, wherein
the program causes a computer to execute a method for controlling a notification apparatus connected to a display apparatus on which an image is displayed, and
the method includes:
displaying part of data containing at least one object, on a screen;
specifying an object not displayed on the screen, based on position information on the respective objects in the data; and
notifying information on the specified object.
